(19) United States
(12) Patent Application Publication
(10) Pub. No.: US 2008/0204872 A1
(43) Pub. Date: Aug. 28, 2008

(54) Autostereoscopic Display Apparatus

(75) Inventors: Willem L. Ijzerman, Eindhoven (NL); Siebe T. De Zwart, Valkenswaard (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/995,574

(22) PCT Filed: Jul. 12, 2006
(86) PCT No.: PCT/IB2006/052369

§ 371 Date: Jan. 14, 2008

(30) Foreign Application Priority Data
Jul. 14, 2005 (EP) 05106484.8
Jul. 12, 2006 (IB) PCT/IB2006/052369

(51) Int. Cl. H04N 13/00

(52) U.S. Cl. 359/463

(57) ABSTRACT

An 2D/3D autostereoscopic display apparatus comprising a display device (301) is configured to display an image. The display device (301) comprises a plurality of pixels (304, 305). The pixels comprise at least a first group of pixels configured to emit light having a first state of polarization and at least a second group of pixels configured to emit light having a second state of polarization. The apparatus further comprises lenticular means comprising an array of birefringent lenticular elements (307, 317) configured to direct the light output of at least one of said groups of pixels such that the respecttive light (314, 315) output of said groups of pixels is emitted in mutually different directions so as to enable a stereoscopic perception of the displayed image. 2D and 3D areas can be displayed simultaneously. Switchable birefringent lenticutar elements provide a switchable 2D/3D display.

The present invention relates to an autostereoscopic display apparatus comprising an image display device and lenticular means.

Three dimensional imaging is a well-known technique today. However, traditionally it has been in the form of stereoscopic images where the user has had to have optical manipulating devices of a kind, especially glasses providing separated light transmission in order to obtain the three dimensional effect.

A more recent development is the ability to construct displays with inherent 3D capabilities with no need for extra equipment for the user to carry. Such a technology is autostereoscopy.

Autostereoscopy is a technique that is based on directing light emanating from a two dimensional display array of pixels in different directions. The different directions of the light results in a slight angular disparity, which, by the slightly separated eyes of a human, makes the image being perceived as having three dimensions. One example of an autostereoscopy technique is parallax barriers. A parallax barrier causes the light direction separation by means of alternating transmissive and opaque regions such as slits or light lines interspersed by dark regions. Another example of an autostereoscopy technique is the use of lenses in front of a display device. One example of such a device is described in International Patent Application WO 98/21620.

International Patent Application WO98/21620 discloses an array of lenticular elements at the output side of a display device. Different groups of pixels, forming one or more stereoscopic pairs, are seen by respective eyes of a viewer through the lenticular elements. The lenticular elements include electrooptic material having a refractive index that is switchable in order to enable removal the refracting effect of the lenticular elements.

However, the solution disclosed in WO 98/21620 has limited capabilities to produce several windows in 3D while the remainder of the display is in 2D mode. The passive matrix addressing used for this can only create a limited number of 3D windows due to the small addressing window of the lenses. In particular, this becomes a drawback in, for instance, computer displays having windows environments where it is desirable to produce 3D icons.

It is an object of the present invention to overcome drawbacks of prior art solutions, and to provide a 2D/3D switchable display which is cheaper to manufacture and allows an arbitrary number of 2D and 3D areas to be displayed simultaneously.

According to the present invention there is provided an autostereoscopic display apparatus comprising a display device configured to display an image, said display device comprising a plurality of pixels. The pixels comprise at least a first group of pixels configured to emit light having a first state of polarization and at least a second group of pixels configured to emit light having a second state of polarization. The apparatus further comprises lenticular means comprising an array of birefringent lenticular elements configured to direct the light output of at least one of said groups of pixels such that the respective light output of said groups of pixels is emitted in mutually different directions so as to enable a stereoscopic perception of the displayed image.

The groups of pixels of said display apparatus are thus configured to emit light of fixed first and second states of polarization respectively. The optical means, such as a birefringent lenticular, then redirects the light of one state of polarization while leaving light of the other state of polarization unaltered.

Preferably, the light is linearly polarized and also preferably, the directions of polarization of the two states are orthogonal.

According to one embodiment of the invention, the birefringent lenticular elements are switchable between a first state in which the light output directing action of the lenticular means is provided and a second state in which the light output directing action is removed. In this way the display can be used in two modes, a 2D-mode and a 3D-mode, with an arbitrary number of three dimensional windows and fully two dimensional with improved resolution.

Preferably, the lenticular means comprise electro-optic material with refractive index switchable by selective application of an electrical potential difference between a first difference value whereby the light output directing action of the lenticular means is provided and a second difference value whereby the light output directing action is removed.

In a further embodiment of the invention, the display apparatus may be configured so that a number of X rows for any N rows of the matrix is/are configured according to the previously stated first and second states of polarization respectively. In specific embodiments, the number X may be 0 or N resulting in a two dimensional or three dimensional image only. It is also feasible that the display apparatus is configured such that the groups of pixels form a checkered pattern.

Additionally, in one embodiment of the invention the lenticular lenses are oriented with a slant angle with respect to the direction of the columns of matrix pixels. This will remove any undesired Moire effects as perceived by a viewer.

In other words, the invention makes use of a display where subsequent sub-pixels have a different polarization state. For instance, light that leaves sub-pixels from the even rows of the display may be linearly polarized in the vertical direction and light that leaves sub-pixels from the odd rows of the display may be linearly polarized in the horizontal direction. In combination with a birefringent lenticular that refracts light that is linearly polarized in the horizontal direction, this arrangement enables light to be directed in two different directions and, hence, enabling the production of three dimensional images to be viewed by an observer. More specifically, only light from the sub-pixels in the odd rows will be refracted, leaving the light from the sub-pixels in the even rows unaltered when passing through the lenticular means.

Accordingly, an advantage with this configuration is the capability to achieve a configuration such that the first set of sub-pixels, those in the odd rows, for instance, create a 3D image while the second set is used to create a 2D image. In the following, the nomenclature 2D and 3D will correspond to two dimensional and three dimensional respectively.

With the configuration as described, a locally 2D/3D switchable display has been created. By selecting the sub-pixels, it is possible to select the mode of the display and, accordingly, an arbitrary number of 2D and 3D windows can be produced simultaneously.

For instance, it will be possible to display documents containing both 2D text and 3D images.

Furthermore, the number of sub-pixels used for 2D and 3D mode respectively can be adjusted depending on the application. For instance, to get an equal resolution in the 2D part and each view of the 3D part a single row of 2D sub-pixels can be used for every number of N rows of 3D sub-pixels for an N view multi-view display.

Embodiments of the present invention will now be described, by way of examples only, with reference to the accompanying drawings, in which:

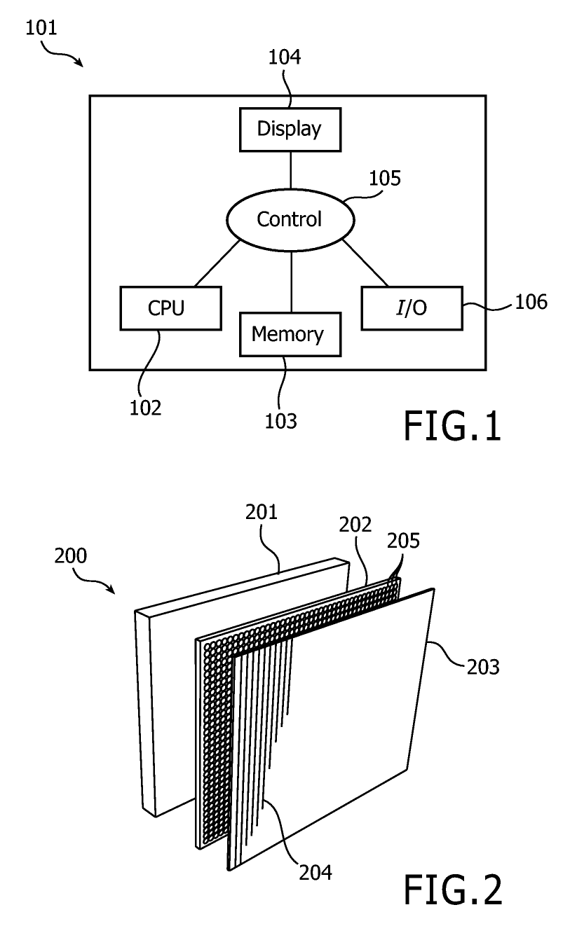

FIG. 1 shows schematically a block diagram of an autostereoscopic display apparatus according to the present invention;

FIG. 2 shows schematically a perspective view of one embodiment of the layers of a display device according to the invention;

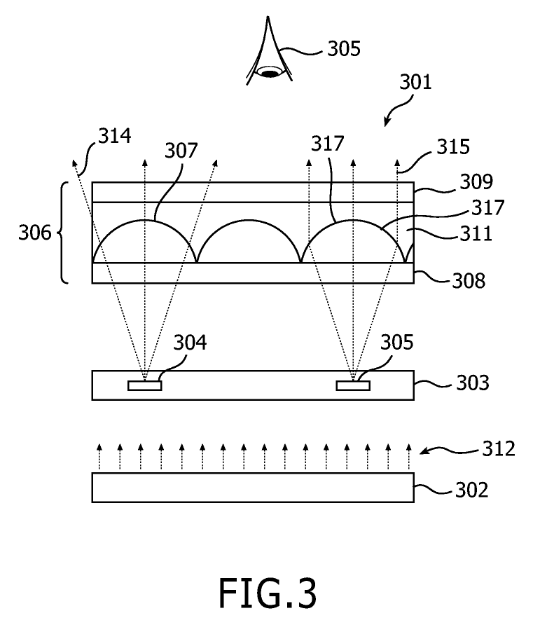

FIG. 3 shows schematically a cross section of a briefringent lenticular according to the invention;

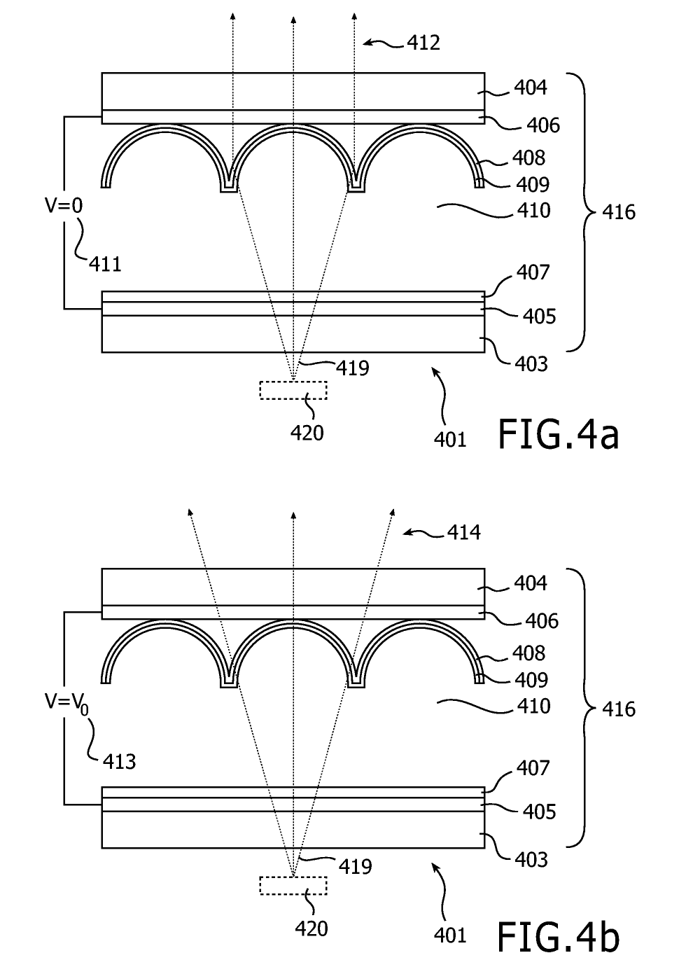

FIGS. 4a and 4b show schematically a cross section of a switchable lens according to one embodiment of the invention;

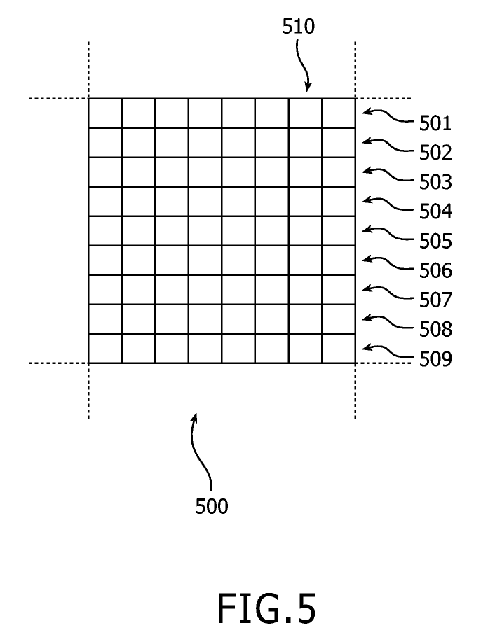

FIG. 5 shows schematically a pixel matrix according to one embodiment of the invention.

FIG. 1 illustrates schematically an autostereoscopic display apparatus 101 in which the present invention is implemented. The apparatus 101 is capable of processing signals for the production of images. The apparatus 101 comprises a processor 102, memory 103, a display device 104, a control unit 105 as well as an input/output unit 106 for receiving information signals from an external unit (not shown) such as a computer. The general features regarding how these units communicate and operate are known to the person skilled in the art and is therefore not discussed further.

FIG. 2 is a schematic view of a display device 200 according to the invention. The display device 200 may be similar to the display device 104 in the apparatus 101 in FIG. 1. The display device 104 comprises a light source 201, a matrix LC display 202 and lenticular means 203. The lenticular means 203 comprise birefringent lenticular elements 204 for refracting light emanating from the LC display 202. The light source 201 illuminates the LC display 202 comprising pixels 205 arranged in a row and column matrix. The light from the light source 201 that illuminates the LC display 202 is modulated in the individual pixels 205 by control means connected to the LC display 202, as the skilled person will realize. For each pixel, the polarization orientation of the modulated light is in one of two linear polarization states. This may be achieved, e.g. as described in “Novel High Performance Transflective LCD with a Patterned Retarder”, S. J. Roosendaal et al, page 78 e.v. SID Digest 2003. A patterned retarder allows the creation of two different polarizations in adjacent sub-pixels. Alternatively, one may also use a patterned polarizer. Here, the orientations are horizontal and vertical polarization. The light from each pixel 205 then enters the lenticular elements 204 where its direction is changed or remains unchanged according to the orientation of the birefringent material in the lenticular elements.

FIG. 3 illustrates schematically a cross section of a small area of a display device 301 such as the display devices 104 and 200 described above. The display device 301 comprises a light source 302, an LC display 303 having a plurality of pixels, of which a first 304 and a second pixel 305 are indicated. Lenticular means 306 are arranged in front of the display as viewed by a viewer 350, and comprises lenticular elements 307 and 317. The lenticular elements 307 and 317 are arranged between a first 308 and a second 309 glass plate. The lenticular elements 307 and 317 comprise an LC material 310 and the remainder of the space between the glass plates 308 and 309 is filled with a plastic material 311. Light 312 emanating from the light source 302 and which have passed through the first 304 and the second 305 pixel of the LC display 303, being polarized when modulated in the pixels, enters the first glass plate 308 and proceeds through the lenticular elements 307 and 317, respectively. In the lenticular element 307, the linearly polarized light in a first direction is refracted 314. In the lenticular element 317, the linearly polarized light in a second direction is unaltered 315.

It is to be noted that it is not necessary that the birefringent lens elements are located between glass plates. The LC may further be polarized to obtain solid birefringent lenses, or the lens material may be stretched plastic.

FIG. 4 is a more detailed view of a display device 401 comprising display means 420 and lenticular means 416, such as the display devices discussed above in connection with FIGS. 1 to 3. FIG. 4a is a cross section of the display device 401 in a refractive state and FIG. 4b is a cross section of the display device 401 depicting a non-refractive state. That is, first and second cross section illustrates the switchability of the lenticular means 416. The display device 401 comprises a first 403 and a second 404 glass plate on which a respective first 405 and a second 406 conductive layer is arranged. The conducting layers are e.g. made of Indium Tin Oxide (ITO) and situated on each of the opposing sides of the glass plates 403 and 404. A first alignment layer 407, such as polymide, is arranged on top of the first conduction layer 405. The rubbing direction of this first alignment layer 407 preferably correspond to the polarization direction of light 419 emanating from sub-pixels of a display device 420 that act as 3D sub-pixels. A negative lens 408 of plastic or any other suitable material is further situated between the glass plates 403 and 404. A second alignment layer 409, also of a material such as polymide, is situated on the side of the lens 408 facing the first glass plate 403 and the space resulting between the lens 408 and the first glass plate 403 is filled with a liquid crystal (LC) material 410.

The first 405 and second 406 conductive layers act as electrodes, where in FIG. 4a no voltage 411 is applied between the electrodes and thereby a birefringent lens effect occurs, refracting the light 419 polarized in a first direction as indicated by refracted beams 412. Hence, with no voltage applied across the lenses 408 the display device 401 can be used in a combined two and three dimensional mode by using an appropriate configuration of first and second groups of sub-pixels with respective first and second states of polarizations as will be described with reference to FIG. 5.

In FIG. 4b, a voltage V₀ 413 is applied between the electrodes and the birefringent lens effect of the lenses 408 is cancelled as is indicated by the unrefracted light beams 414 allowing any light in any polarization state to effectively pass through and, hence, full resolution of the display in the two dimensional mode is achieved.

Properly aligned with the alignment layers 407 and 409, it is the LC material 410 which causes the birefringency effect. Together with the curvature of the plastic lens 408, a lens effect for one state of polarization is obtained when no voltage is applied. However, it is also possible to have other LC materials with other properties as well as other kinds of alignment layers, such that a lens effect is caused when voltage is applied and cancelled when no voltage is applied.

Preferably, the lens arrangement is made of PEN foil that is stretched in one direction, or any other suitable material known to the person skilled in the art.

FIG. 5 will now be used to illustrate a subset of a pixel matrix 500 in an LC display according to an embodiment where the number of sub-pixels used for the 2D and 3D mode has been adjusted to one specific application. The display matrix 500 is divided into rows 501-509 and columns of which one column is indicated by 510. As already discussed above, such a display matrix 500 may be used to obtain an autostereoscopic display apparatus. To get an equal resolution in a 2D area and each view of a 3D area, one row of 2D sub-pixels for every N rows of 3D sub-pixels can be used to create an N view multi-view display. Specifically, in the device of FIG. 5, a pixel layout for a 3 view system is shown where groups of three subsequent rows 501 502, 503 and 506-508 of sub-pixels are used for the creation of 3D information together with single rows 504 and 509 which are used for presentation of 2D information.

In a further embodiment the lenses are arranged at a slant angle with respect to the sub-pixels. Thereby, any moire effects caused by the lens structure is reduced and the perceived image quality may increase.

References made in this document to light linearly polarized in the horizontal and vertical direction should not be limiting, but rather construed as any combination of orthogonal polarized states.

Hence, to summarize, an autostereoscopic display apparatus is described comprising a display device is configured to display an image. The display device comprises a plurality of pixels. The pixels comprise at least a first group of pixels configured to emit light having a first state of polarization and at least a second group of pixels configured to emit light having a second state of polarization. The apparatus further comprises lenticular means comprising an array of birefringent lenticular elements configured to direct the light output of at least one of said groups of pixels such that the respecttive light output of said groups of pixels is emitted in mutually different directions so as to enable a stereoscopic perception of the displayed image.

The person skilled in the art realizes that the present invention by no means is limited to the preferred embodiments described above. On the contrary, many modifications and variations are possible within the scope of the appended claims.

1. An autostereoscopic display apparatus comprising a display device configured to display an image, said display device comprising a plurality of pixels said pixels comprising at least a first group of pixels configured to emit light having a first state of polarization and at least a second group of pixels configured to emit light having a second state of polarization, the apparatus further comprising lenticular means comprising an array of birefringent lenticular elements configured to direct the light output of at least one of said groups of pixels such that the respective light output of said groups of pixels is emitted in mutually different directions so as to enable a stereoscopic perception of the displayed image.

2. An autostereoscopic display apparatus according to claim 1 wherein said polarization states are linear.

3. An autostereoscopic display apparatus according to claim 2 wherein said first and second polarization states are orthogonal.

4. An autostereoscopic display apparatus according to claim 1 wherein said birefringent lenticular elements are switchable between a first state in which the light output directing action of the lenticular means is provided and a second state in which the light output directing action is removed.

5. An autostereoscopic display apparatus according to claim 4 wherein said lenticular means comprise electro-optic material with refractive index switchable by selective application of an electrical potential difference between a first difference value whereby the light output directing action of the lenticular means is provided and a second difference value whereby the light output directing action is removed.

6. An autostereoscopic display apparatus according to claim 1, wherein said pixels are arranged in a row and column matrix and wherein X rows for any N rows of said matrix is/are configured according to said first and second states of polarization respectively.

7. An autostereoscopic display apparatus according to claim 6 wherein X=0 and hence, the display is configured to produce a two or three dimensional image only.

8. An autostereoscopic display apparatus according to claim 6, wherein said groups of pixels form a checkered pattern.

9. An autostereoscopic display apparatus according to claim 6, wherein said lenticular elements are oriented with a slant angle with respect to the direction of the columns of matrix pixels.

10. An autostereoscopic display apparatus according to claim 1, wherein said lenticular elements comprise a birefringent PEN foil.
